(19) United States
(12) Patent Application Publication
(10) Pub. No.: US 2006/0177033 A1
(43) Pub. Date: Aug. 10, 2006

(54) Call management system

(75) Inventors: Malcolm Evatt Keith Allen, Toorak (AU); Gregory Rolan, Cape Paterson (AU)

Correspondence Address: FITCH EVEN TABIN AND FLANNERY, 120 SOUTH LA SALLE STREET, SUITE 1600, CHICAGO, IL, 60603-3406, US

(73) Assignee: FREEDOMTEL PTY LTD, an Australian corporation

(21) Appl. No.: 11/364,302

(22) Filed: Feb. 28, 2006

Related U.S. Application Data
(63) Continuation-in-part of application No. PCT/AU04/01178, filed on Aug. 31, 2004.

(30) Foreign Application Priority Data
Sep. 2, 2003 (AU) 2003904732

(51) Int. Cl. H04M 3/42

(52) U.S. Cl. 379/210.02

(57) ABSTRACT

There is disclosed a system for managing calls between parties in a telecommunication network, the system comprising a database (16,33) having a plurality of records, at least some of the records defining at least one ring time out parameter (RTP), each RTP specifying when a call will be terminated without called party intervention, database checking means (12) for checking the database in response to a calling subscriber initiating a call to a called party to determine whether there is a record that defines an RTP for said called party and retrieving the RTP if an RTP is defined, and call stopping means (13) for stopping the call on the basis of the retrieved RTP if stopping the call is necessary to avoid termination without called party intervention.

### FIELD OF THE INVENTION

The present invention relates to a call management system and method.

### BACKGROUND TO INVENTION

Generally, voice telecommunications networks provide for the establishment of voice calls between an initiating device (the calling party) and a receiving device (the called party). A voice call that is successfully ‘answered’ is termed a ‘terminated’ call and generally results in call charges accruing to the calling party.

Voice telecommunications networks commonly provide a service to subscribers whereby if a subscriber device of a called party (a) does not answer the call; (b) is engaged in another call; or (c) is not present on the network (such as is possible in a wireless device scenario), the network redirects the call to an in-network messaging service, terminates the call, introduces the mailbox, records a message intended for the called party, and notifies the called party subscriber of the existence of such messages. Subsequently the called party subscriber places a call to the in-network messaging service, listens to any pending voice messages and manages their mailbox.

The main characteristic of common voice telecommunication networks with such voice messaging services is that, unless a calling party ‘hangs up’ prematurely while the called party device is ringing, all calls are usually terminated—either by the called party device or by the in-network messaging service—regardless of whether the calling party subscriber would wish for call termination to occur in the event that the called party does not answer the call—i.e. the call is not terminated directly with the called party. Similarly, called party subscribers must place a terminated call to the in-network messaging service to retrieve the message, regardless of cost or whether they wish to receive messages from the calling party. The called party is often charged for the diversion of the message to the messaging service and the subsequent retrieval of the message.

It would be advantageous to provide an alternative call management system which is capable of delivering cost savings and call management benefits.

### SUMMARY OF THE INVENTION

The invention provides a system for managing calls between parties in a telecommunication network, the system comprising:

a) a database having a plurality of records, at least some of the records defining at least one ring time out parameter (RTP), each RTP specifying when a call will be terminated without called party intervention;

b) database checking means for checking the database in response to a calling subscriber initiating a call to a called party to determine whether there is a record that defines an RTP for said called party and retrieving the RTP if an RTP is defined; and

c) call stopping means for stopping the call on the basis of the retrieved RTP if stopping the call is necessary to avoid termination without called party intervention.

Thus, by stopping the call before it is terminated, the calling party is not charged for call termination. The RTP may be defined as a specific value within the record or may be defined by information from which the RTP can be derived.

In a typical embodiment of the invention, each subscribers' subscriber device comprises a SPD checking means and a call stopping means.

The SPD may be configured to allow each subscriber to update their own subscriber record.

The SPD may be configured in update subscriber records based on the presence/absence of a subscriber device on/from a network.

In some embodiments, the system has:

a central SPD having records for each subscriber or class of subscribers, the central SPD being accessible by each subscriber;

a local SPD storing at least a portion of the records of the central SPD; and

database synchronization means for synchronizing the contents of the central SPD with the contents of the local SPDs.

The central SPD may be distributed or replicated. Typically, the system further comprises message recording means in each subscriber device for optionally recording a message in the calling party's subscriber device when said call stopping means stops a call; and

message forwarding means for forwarding said message to a called party.

The message forwarding means may take a number of different forms, or indeed a plurality of message forwarding techniques may be available to each subscriber and said subscriber device has forwarding technique selection means. The forwarding technique selection means may be configured to select a forwarding technique based on cost benefit or based on subscriber preference.

Message forwarding techniques may include, for example, a short messaging service (SMS), a multimedia messaging service (MMS), direct peer-to-peer messaging, e-mail, or forwarding the message to a message storage database that subscriber devices can check on a periodic basis or in response to a notification such as an SMS.

Thus subscribers can still leave messages for one another but at a lower cost than is incurred currently.

Preferably, the subscriber records also define at least one message forwarding parameter (MFP) which indicates where messages destined for the called party are to be sent.

The MFP may be a specific value within the record or may be defined by information from which the MFP can be derived.

The invention also provides a method for managing calls between parties in a telecommunication network, the method comprising:

a) maintaining a plurality of records, at least some of the records defining a ring time out parameter (RTP), each RTP indicating when a call to a called party will be terminated without called party intervention;

b) checking the records in response to a calling subscriber initiating a call to a called party to determine whether there is a record that defines an RTP for the called party and retrieving the RTP if an RTP is defined; and

c) stopping the call on the basis of the retrieved RTP if stopping the call is necessary to avoid termination without called party intervention.

The invention also provides a system for managing calls between parties in a telecommunication network, the system comprising:

a) message recording means in each of a plurality of subscriber devices for recording a voice message of a calling subscriber to a called party; and

b) message forwarding means for forwarding a recorded message to a called party.

Preferably, said system comprises a database having a plurality of records for each subscriber, at least some records defining a MFP which indicates where messages destined for a called subscriber are to be sent.

### BRIEF DESCRIPTION OF THE DRAWINGS

A preferred embodiment of the invention will now be described in relation to the accompanying drawing,

FIG. 1, which is a system diagram of a preferred embodiment.

### DESCRIPTION OF THE PREFERRED EMBODIMENT

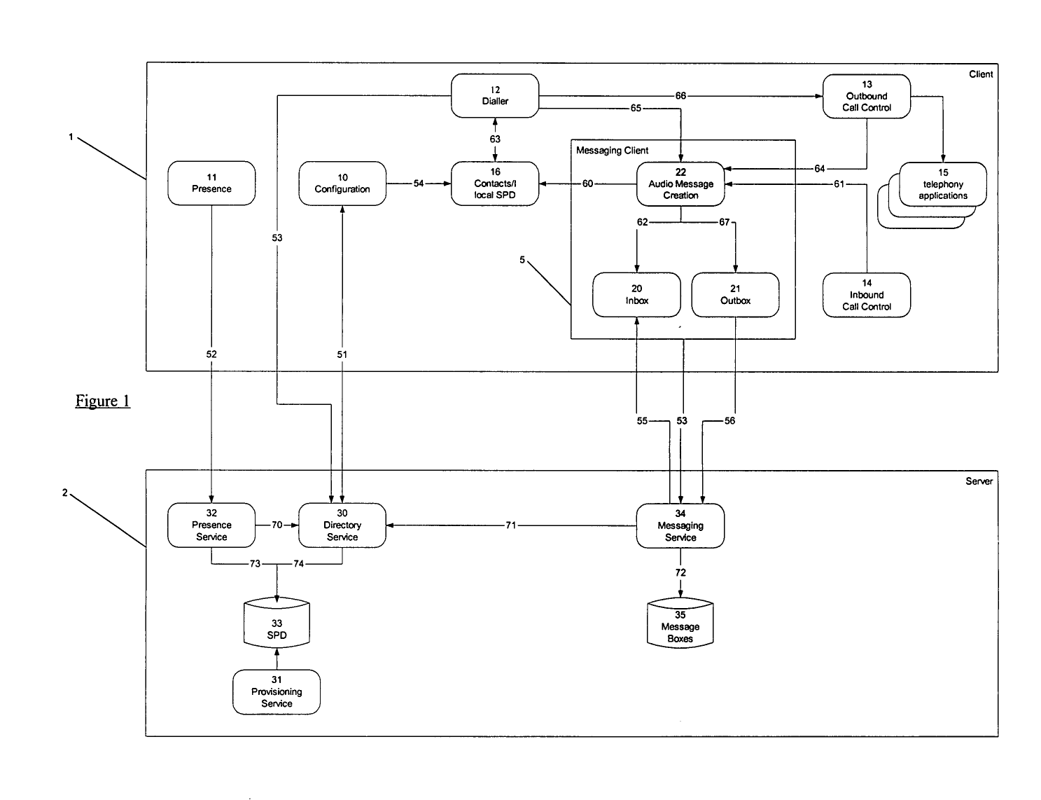

Referring to FIG. 1, the call management system comprises a number of client-side 1 and server-side 2 components.

In the preferred embodiment, a subscriber device of the call management system is registered in a directory service 30 which is one part of a subscriber preferences data-store 33 maintained on the server 2. Registration takes place prior to the subscriber device being active as a subscriber and is performed via a provisioning application 31 which will typically be a back office function accessible by administration of the call management system. However, it may also include an interface which allows outside parties to administer subscribers for whom they are responsible.

The registration process allocates a system identifier (sysid) to the subscriber device and records the subscriber name, available networks, RTPs, MFPs and other information in a record for the subscriber.

The subscriber's subscriber device may be connected to a number of voice and/or data network services. Each of these associations involves items of identification and configuration that are relevant to the call management system and are included in the subscriber record.

An example is shown in Table 1 which demonstrates various network services and the associated identifiers for a subscriber.

TABLE 1
Example Network/System Identifiers

| Network/Service | Identifier |
|---|---|
| Dynamic TCP/IP network | IP address |
| Mobile telephony | Telephone number |
| VOIP network | VOIP identifier |
| E-mail | E-mail address |
| Call management system | Subscriber's name System Identifier |

The client device maintains its own set of configuration information, comprising the sysid, subscriber name and network identifiers, together with other local configuration data including the subscriber's RTPs and MFPs using the client-side configuration control component 10. Message forwarding techniques may include, for example, a short messaging service (SMS), a multimedia messaging service (MMS), direct peer-to-peer messaging, e-mail, or forwarding the message to a message storage database which subscriber devices can check on a periodic basis or in response to a notification such as an SMS.

Once registered, from within the client-side configuration control component 10, a subscriber device can synchronise 51 configuration information with the directory service 30 and obtain relevant SPD information about other subscribers. This returned information is stored 54 in a contacts/local SPD store 16.

The synchronisation transaction 51 can occur via any of the data networks which link the device and the server. Which network is used can be specified by subscriber preferences in the device. Transactions are typically encrypted, authenticated and authorised to avoid tampering.

The directory service 30 may be queried 70, 71 for the subscriber information that matches a given identifier by other server-side components. Note that directory queries are not performed directly by the subscriber devices, but by other server-side services such as the messaging service 34 and the presence service 32.

Directory queries are performed by matching a query key, being any of the subscriber identifiers published in the directory. Imperfect matches may be resolved by heuristics to give a unique match. If any identifier is matched, that subscriber record is returned. In this way, subscriber devices do not need to know the sysid of any other subscriber with which they wish to initiate a messaging transaction—only one of the called party's publicly published identifiers.

Subscriber information in the SPD 33 may incorporate Ring Time Out Parameter (RTP) and Message Forwarding Parameter (MFP) information including:
Global Parameters (synchronised 51 from the subscriber 10);
Network specific Parameters for the network(s) to which the subscriber device is subscribed (synchronised 51 from the subscriber 10);
Parameters, or raw information from which a Parameter may be determined (e.g. the MFP or RTP), specific to individual caller or caller groups (e.g. white/black lists) (synchronised 51 from the subscriber 10);
Parameters, or raw information from which Parameters may be determined, based on clock/calendar/location/time zone or other subscriber device information (synchronised 51 from the subscriber 10);
Parameters, or raw information from which Parameters may be determined, based on the subscriber device's presence or absence in the network(s) to which it is subscribed. This information is updated 73 from the presence service 32 and may be obtained either via the subscriber device reporting 52 its presence on the network(s) to which it is subscribed to the presence service 32, or the presence service 32 detecting the presence or absence of a client device in the network(s) to which it is subscribed.

In the preferred embodiment, subscriber devices report their presence 52 on the various services and networks to which they are subscribed to the presence service 32 by means of the client-side presence-reporting component 11. The presence service 32 updates 73 the SPD 33.

In the preferred embodiment the presence information comprises:
The sysid of the reporting subscriber device;
A present/not-present flag for each subscribed network;
If required, transient configuration information (e.g. IP address) for each subscribed network;
An optional RTP dynamically specified for each subscribed network.

The presence-reporting transaction 52 occurs via any of the data networks to which the device is connected—according to subscriber preferences.

Other mechanisms for determining the RTP will be apparent to persons skilled in the art and should be considered as falling within the scope of the described invention.

When required, the dialling function 12 of the subscriber device queries 53 the directory service 30 for the status of the called subscriber device. In response, the relevant subscriber information including the RTP information may be returned 53.

Subscriber status queries 53 are performed against a publicly published called party identifier.

A status query 53 may return either an RTP or raw information from which an RTP may be derived. The calling party device then uses this information to determine whether to place the call to the called party and if so over what network. For example, an RTP of zero may mean that the call is not to be attempted.

A messaging service is provided which allows subscribers to send voice messages to and receives voice messages from other subscribers.

A message includes:
Recipient (called party) list
Message status flags (priority, confidentiality, return receipt required etc.)
Sender (calling party)
Subject
Text component
Multimedia component(s)

The messaging client 5 maintains a message inbox 20 and message outbox 21.

In the preferred embodiment, to send a message to one or more other subscribers the subscriber devices create a message using the audio message generation client 22, which records the subscriber's message, adds relevant messaging information including the preferred message destination and route and injects it 67 in its Outbox 21.

To retrieve messages, the subscriber device 1 queries 57 the messaging service 34 for any pending messages. If pending messages exist, they are transferred 55 to the subscriber 1 and stored in the inbox 20. Subscriber devices 1 query 57 the Message Service 34 (either upon manual instruction, automatically at regular intervals or after notification) for any pending messages in its corresponding Message Box 35.

Transfer of messages is via the messaging service 34. The messaging service 34 maintains a message box 35 for each subscriber.

Messages residing in the Outbox 21 are transferred 56 to the messaging service 34 which resolves the provided recipient identifier to a sysid via a query 71 to the directory service 30.

The messaging service 34 then places 72 the message in the message box 35 for the given called party.

The messaging transactions can occur via any of the data networks to which the device is connected—according to subscriber preferences. For example, message forwarding techniques may include, for example, a short messaging service (SMS), a multimedia messaging service (MMS), direct peer-to-peer messaging, e-mail, or forwarding the message to a message storage database that subscriber devices can check on a periodic basis or in response to a notification such as an SMS.

When an inbound call is received and continues after a user-configured 10 duration of unanswered ringing, typically caused by calls from a non-subscriber or incorrect RTP, or based on called party preferences, the Inbound Call Control 14 terminates the call, plays an inbound-message, invokes 61 the messaging client 5 and records a voice message 22 if the calling party caller leaves one.

Message creation also involves determining the calling party via correlation 60 of the telephony call information and the local client's contacts list/local SPD 16. The calling party may be described as a name (from the contacts list), an uncorrelated telephone number, or ‘UNKNOWN’.

The called party held in the message is set to the subscriber name and standard subject and text components are created from the date/time of call. The recorded voice message is the multimedia component. The message is then injected 62 into the local client inbox 20.

The subscriber places an outbound call by invoking the dialler 12—either through an integrated context menu interface 63 with the local contacts list/local SPD, or directly by entering a number.

The dialler 12 then determines which messaging transaction to initiate by initially performing a status query 53 and/or 63 on the supplied identifier. Thus, the dialler provides SPD checking means.

If the status query returns ‘NOT A SUBSCRIBER’ (i.e. the called party is not a subscriber) then the dialler will place a conventional voice call.

If the status query returns an RTP of zero or information from which an RTP of zero can be derived, then the dialler will take a message or place a conventional voice call depending on the calling party's over-ride preferences.

If the status query returns that a non-zero RTP or information from which a non-zero RTP can be derived, then the calling party obtaining the RTP is connected to one or more voice networks and the dialler will place a voice call.

The dialler 12 determines over which network to initiate the messaging transaction. The subscriber device will either be off network or connected to one or more voice networks and one or more data networks—with associated cost and quality characteristics.

Typically a subscriber device will have voice capability over GSM, and data capability over GPRS and WIFI, however the subscriber device may well be able to avail itself of other networks.

When the subscriber device places a voice call to a subscriber, the dialler will determine the appropriate voice telephony application 15, transport and network, based on a cost/quality or other heuristic. If the dialler 12 decides to initiate 65 a local voice message, a message is created using the audio message creation component 22. In which case, a notification message is played and the subscriber is given an opportunity to record a message 22.

The calling party is set to the client subscriber name by the message creation means and the called party is set to the identifier passed to the dialler 12. The preferred transmission network is set by the MFP. Standard subject and text components are created from the date/time of call and the recorded voice message is the multimedia component created by the audio message creation component 22. The message is then injected 67 into the local client outbox 21.

If the dialler 12 decides to place an outbound voice call, the call is initiated on the appropriate voice telephony application 15, transport and network and outbound call control 13 is invoked 66 to manage the call.

If the call returns a busy signal, then the outbound call control component 13 stops the call and initiates 64 the creation and injection of a message as above.

If the call is detected to be in the ringing state for the duration specified in the RTP, then Outbound Call Control component 13 stops the call and initiates 64 the creation and injection of a message.

Accordingly, the preferred embodiment provides the following for telecommunications messaging devices:
The capability of devices to advertise and receive network configuration and calling preference information, such as status and call answering preferences, about itself and other devices on a network.
The capability to perform outbound voice call control on the calling party device, Aborted Outbound Voice Call, by pre-emptively not placing an outbound voice call if that is to a Called party device with an RTP of zero or has provided calling preference information indicating that they will not answer a call from the Calling party; and/or
Ceasing the establishment of an outbound voice call if the subscriber Called party device has not answered in a prescribed duration, or returns a busy signal.
In the event of a stopped Outbound Voice Call, the capability to notify the calling party caller of the event and provide, in the calling party device, for the generation or recording of a message destined for the subscriber called party.
The capability to transmit the message, over a data network, directly to the Called party device to another party or a message store-and-forward service.
The retrieval by the B party of messages destined for the B party device, directly from the calling party device or a message store-and-forward service.

In an alternative embodiment, a central subscriber preferences database is maintained on the server 2 and, subscriber preference databases are maintained on each of the subscriber devices 1. The dialler 12, then checks the local subscriber preferences database rather than the central SPD. This reduces the time required to initiate a voice call. If this embodiment is employed, the subscriber devices are configured to periodically synchronise themselves with the central preferences database. For example, each time the subscriber device turns on and then at fixed periods. The local SPD may be a subset of the central SPD which is specific to the subscriber. Persons skilled in the art will also appreciate that the central SPD may be distributed or replicated.

While the invention has been described in relation to a subscriber database where there are records for each subscriber, it will be appreciated that the invention can be extended to a case where there are records for classes of subscribers, records for non-subscribers, and/or records for classes of non-subscribers. In this case it is more appropriate to refer to a database rather than a subscriber preferences database to the extent that some of the records do not relate to subscribers. Clearly in a calling system it is not necessary to list all possible called numbers as individual records and some may be treated as classes. For example, for all numbers not individually listed in the SPD, the RTP could be to automatically to stop the call after a default of ten seconds and not to forward a message. For all international numbers listed in the SPD stop the call the after eight seconds or for all local calls stop the call immediately on an engaged signal. It is also possible that there may be non-subscribers or classes of non-subscribers to whom messages can be forwarded—e.g. if calling a non-subscriber land line for which an e-mail address is registered, the RTP may be automatically set for five rings before a voice message is taken and sent as an e-mail attachment. Such methods may become more and more popular as hand-held devices which can receive e-mail wirelessly become more available.

Persons skilled in the art will also appreciate that the system may incorporate a plurality of subscriber preferences databases dedicated to specific groups of subscribers. For example, if the system is adopted by a large company, there may be a specific subscriber preference database for that company that can have records which define how calls made by subscribers from that country are terminated.

Other variations will be apparent to persons skilled in the art and should be considered as falling within the scope of the described invention

1. A system for managing calls between parties in a telecommunication network, the system comprising:
a) a database having a plurality of records, at least some of the records defining at least one ring time out parameter (RTP), each RTP specifying when a call will be terminated without called party intervention;
b) database checking means for checking the database in response to a calling subscriber initiating a call to a called party to determine whether there is a record that defines an RTP for said called party and retrieving the RTP if an RTP is defined; and
c) call stopping means for stopping the call on the basis of the retrieved RTP if stopping the call is necessary to avoid termination without called party intervention.

2. A system as claimed in claim 1, wherein said database provides a subscriber preferences database (SPD) and said plurality of records include subscriber records for each subscriber or class of subscribers.

3. A system as claimed in claim 1, wherein said database has records defining RTPs for at least one subscriber or class of subscriber and for at least one non-subscriber or class of non-subscriber.

4. A system as claimed in claim 1, wherein each record that defines an RTP contains a value of the RTP.

5. A system as claimed in claim 1, wherein the subscriber record contains information from which the RTP can be derived and the system comprises means for deriving an RTP from said information.

6. A system as claimed in claim 1, comprising a plurality of subscriber devices, and wherein each subscriber device comprises a database checking means and a call stopping means.

7. A system as claimed in claim 2, wherein the SPD is configured to allow each subscriber having a subscriber record to update their own subscriber record.

8. A system as claimed in claim 1, wherein the SPD is configured in update subscriber records based on the presence or absence of a subscriber device on or from a network.

9. A system as claimed in claim 2, wherein said SPD comprises:
a central SPD having records for each subscriber of class of subscriber, the central SPD being accessible by each subscriber;
a local SPD for at least one subscriber storing at least a portion of the records of the central SPD and accessible by said at least one subscriber; and wherein the system comprises database synchronization means for synchronizing the contents of the central SPD with the contents of the local SPDs.

10. A system as claimed in claim 6, further comprising:
message recording means in each subscriber device for optionally recording a message in the calling party's subscriber device when said call stopping means stops a call; and
message forwarding means for forwarding said message to a called party.

11. A system as claimed in claim 10, wherein said message forwarding means comprises means for forwarding messages in accordance with at least one of the messaging techniques selected from the group of: a short messaging service (SMS); a multimedia messaging service (MMS); direct peer-to-peer messaging; e-mail; and forwarding the message to message storage database that subscriber devices can check on a periodic basis or in response to a notification such as an SMS.

12. A system as claimed in claim 10, wherein said message forwarding means comprises two or more message forwarding techniques and said subscriber device has forwarding technique selection means.

13. A system as claimed in claim 12, wherein the forwarding technique selection means is configured to select a forwarding technique based on cost benefit.

14. A system as claimed in claim 12, wherein the forwarding technique selection means is configured to select a forwarding technique based on a subscriber preference.

15. A system as claimed in claim 1, wherein at least some records also define at least one message forwarding parameter (MFP) that indicate where messages destined for the called party are to be sent.

16. A system as claimed in claim 15, wherein each record contains a value of the MFP.

17. A system as claimed in claim 15, wherein each record contains information from which the MFP can be derived.

18. A method for managing calls between parties in a telecommunication network, the method comprising:
a) maintaining a plurality of records, at least some of the records defining a ring time out parameter (RTP), each RTP indicating when a call to a called party will be terminated without called party intervention;
b) checking the records in response to a calling subscriber initiating a call to a called party to determine whether there is a record that defines an RTP for the called party and retrieving the RTP if an RTP is defined; and
c) stopping the call on the basis of the retrieved RTP if stopping the call is necessary to avoid termination without called party intervention.

19. A method as claimed in claim 18, comprising:
recording a message in the calling party's subscriber device after stopping a call; and
forwarding said message to a called party.

20. A system for managing calls between parties in a telecommunication network, the system comprising:
a) message recording means in each of a plurality of subscriber devices for recording a voice message of a calling subscriber to a called party; and
b) message forwarding means for forwarding a recorded message to a called party.

21. A system as claimed in claim 18 comprising a database having a plurality of records, at least some records defining a message forwarding parameter (MFP) which indicates where messages destined for a called party are to be sent.
